(19) United States
(12) Patent Application Publication
(10) Pub. No.: US 2010/0251774 A1
(43) Pub. Date: Oct. 7, 2010

(54) CREEP RESISTANT MULTIPLE LAYER REFRACTORY USED IN A GLASS MANUFACTURING SYSTEM

(75) Inventor: Irene M. Peterson, Elmira Heights, NY (US)

Correspondence Address: CORNING INCORPORATED, SP-TI-3-1, CORNING, NY, 14831, US

(73) Assignee: Corning Incorporated

(21) Appl. No.: 12/744,585

(22) PCT Filed: Nov. 19, 2008
(86) PCT No.: PCT/US08/12926

§ 371 Date: May 25, 2010

Related U.S. Application Data
(60) Provisional application No. 61/004,650, filed on Nov. 29, 2007.

(51) Int. Cl. C03B 17/06; C03B 19/06; C04B 35/00

(52) U.S. Cl. 65/193; 65/60.1; 65/374.13

(57) ABSTRACT

An isopipe for use in a glass manufacturing system is described herein that has core portion made of a refractory material selected both for its refractory characteristics as well as its ability to withstand creep, and an outermost layer made from a second refractory material selected both for its refractory properties as well as its compatibility with contacting molten glass during a fusion glass forming process (e.g. low solubility in the glass). In addition, a method of making an isopipe have a core made of one refractory material and at least one layer covering the core made from another refractory material is disclosed.

### CLAIMING BENEFIT OF PRIOR FILED U.S. APPLICATION

This application claims the benefit of U.S. Provisional Application Ser. No. 61/004,650, filed on Nov. 29, 2007. The content of this document and the entire disclosure of publications, patents, and patent documents mentioned herein are incorporated by reference.

### TECHNOLOGICAL FIELD

The present invention relates to a multi-layered refractory material that may be used to make a forming vessel (isopipe) that is used in making sheet glass by a fusion process. The invention also relates to a method for making the forming vessel.

### BACKGROUND

Corning Incorporated has developed a process known as the fusion process (e.g., downdraw process) to form high quality thin glass sheets that can be used in a variety of devices like flat panel displays. The fusion process is the preferred technique for producing glass sheets used in flat panel displays because this process produces glass sheets whose surfaces have superior flatness and smoothness compared to glass sheets produced by other methods. The fusion process is described in U.S. Pat. Nos. 3,338,696 and 3,682,609, the contents of which are incorporated herein by reference.

The fusion process makes use of a specially shaped refractory block referred to as an isopipe (e.g., forming vessel) over which molten glass flows down both sides and meets at the bottom to form a single glass sheet. Although the isopipe generally works well to form a glass sheet, the isopipe is long compared to its cross section and as such can creep or sag over time due to the load and to the high temperature associated with the fusion process. When the isopipe creeps or sags too much it becomes very difficult to control the quality and thickness of the glass sheet. Certain materials are more susceptible to creep than others. However, the refractory material that contacts the glass must be carefully selected such that reaction between the refractory material and the glass itself is minimized. For example, alumina (Al₂O₃) is a refractory material that is more resistant to creep than zircon (ZrSiO₄), a common refractory used in isopipe manufacture. However, at high temperature and while contacting glass, alumina will dissolve into the glass, raising the liquidus of the glass and causing undesired crystallization of high alumina phases such as mullite in the glass. Although zircon shows some solubility in glass, it is far less soluble than alumina and therefore more resistant to crystal formation. Further, due to the solubility of alumina, it is more prone to dissolution of the refractory and therefore has a shorter usable life.

### SUMMARY

The present invention includes an isopipe having a core portion made of a refractory material selected both for its refractory characteristics as well as its ability to withstand creep, and an outermost layer made from a second refractory material selected for its refractory properties, its resistance to wear, as well as its compatibility with contacting molten glass during a fusion glass forming process (e.g. low solubility in the glass). Additionally and in order to address potential incompatibility (e.g. CTE) of the refractory materials chosen for the core and outermost layer, the invention further provides intermediate layers between the core and outermost layers. The intermediate layers will also be made of refractory materials compatible with the high temperatures associated with glass manufacture. In one aspect, the intermediate layers create a composition gradient between the refractory material in the core and the refractory material in the outermost layer.

Further disclosed is a method of making a creep resistant isopipe including the steps of: forming a refractory block from a first refractory material; sintering the block; machining out a core isopipe structure from the sintered block; coating the core with a slurry comprising a second refractory material and a binder; heating the slurry to a suitable temperature to eliminate voids, burn off the binder and densify the second refractory material; and repeating the coating and heating steps with differing refractory materials for each layer until a desired number of layers are created over the core.

### BRIEF DESCRIPTION OF THE DRAWINGS

A more complete understanding of the present invention may be obtained by reference to the following detailed description when taken in conjunction with the accompanying drawings wherein:

FIG. 1 is a block diagram illustrating an exemplary glass manufacturing system including an isopipe made in accordance with the present invention;

FIG. 2 is a perspective view illustrating in greater detail the isopipe used in the glass manufacturing system shown in FIG. 1;

FIG. 3 is a cross sectional view of an isopipe embodiment having a core and an outermost layer as made in accordance with the present invention; and

FIG. 4 is a cross sectional view of an isopipe embodiment having a core, an intermediate layer, and an outermost layer as made in accordance with the present invention.

### DETAILED DESCRIPTION OF THE DRAWINGS

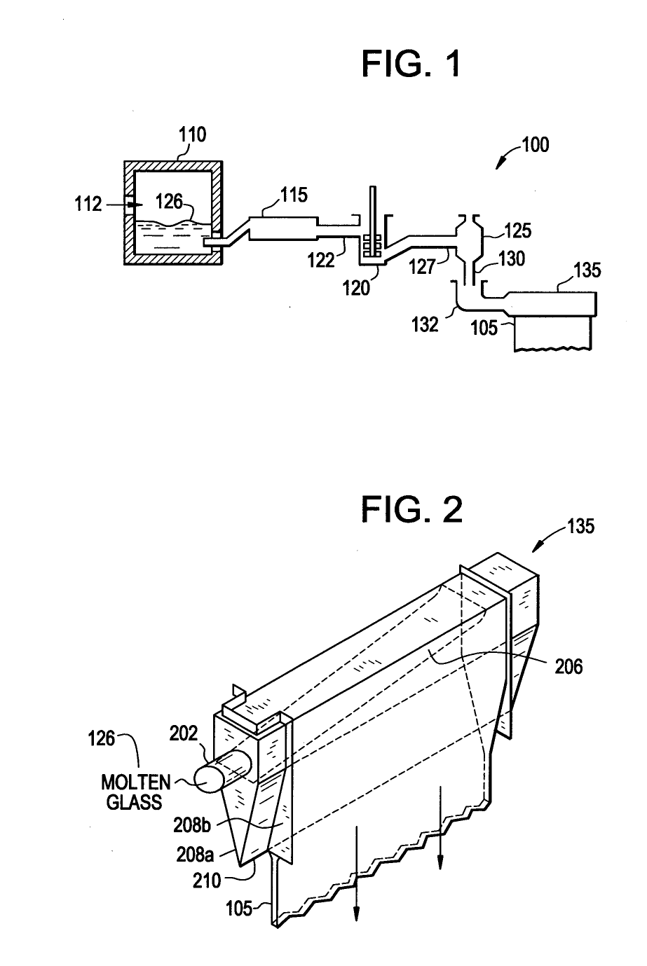

Referring to FIG. 1, there is shown a schematic view of an exemplary glass manufacturing system 100 that uses the downdraw fusion process to make a glass sheet 105. The glass manufacturing system 100 includes a melting vessel 110, a fining vessel 115, a mixing vessel 120 (e.g., stir chamber 120), a delivery vessel 125 (e.g., bowl 125) and a forming vessel 135 (e.g., isopipe 135). As used in this specification and in the claims, the term “isopipe” means any sheet forming delivery system used in a fusion process which produces flat glass wherein at least a part of the delivery system comes into contact with the glass just prior to fusion, irrespective of the configuration or the number of components making up the delivery system. The melting vessel 110 is where the glass batch materials are introduced as shown by arrow 112 and melted to form molten glass 126. The fining vessel 115 (e.g., finer tube 115) receives the molten glass 126 (not shown at this point) from the melting vessel 110 and removes bubbles from the molten glass 126. The fining vessel 115 is connected to the mixing vessel 120 (e.g., stir chamber 120) by a finer to stir chamber connecting tube 122. The mixing vessel 120 is connected to the delivery vessel 125 by a stir chamber to bowl connecting tube 127. The delivery vessel 125 delivers the molten glass 126 through a downcomer 130 to an inlet 132 and into the forming vessel 135 (e.g., isopipe 135) which forms the glass sheet 105. The forming vessel 135 (e.g., isopipe 135) which is made from the refractory materials in accordance with the present invention is shown in greater detail below with respect to FIG. 2.

Referring to FIG. 2, there is shown a perspective view of the isopipe 135 used in the glass manufacturing system 100. The isopipe 135 includes an opening 202 that receives the molten glass 126 which flows into a trough 206 and then overflows and runs down two sides 208a and 208b before fusing together at what is known as a root 210. The root 210 is where the two sides 208a and 208b come together and where the two overflow walls of molten glass 126 rejoin before being drawn downward and cooled to form glass sheet 105. It should be appreciated that the isopipe 135 and the glass manufacturing system 100 can have different configurations and components other that those shown in FIGS. 1 and 2 and still be considered within the scope of the present invention.

As shown in FIG. 2, the isopipe 135 is long compared to its cross section so it is important that the isopipe 135 does not creep over time due to the load and high temperature associated with the fusion process. If the isopipe 135 creeps or sags too much then it becomes difficult to control the quality and thickness of the glass sheet 105.

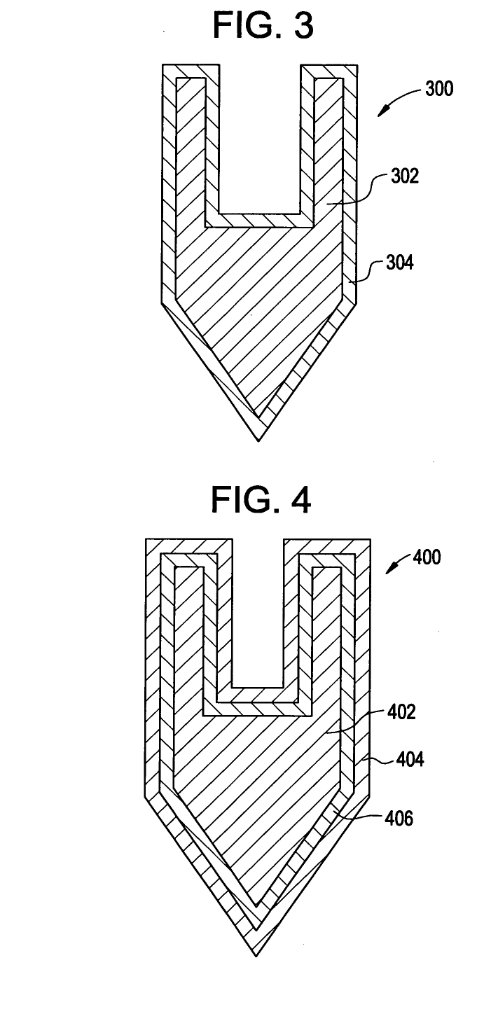

As shown in FIG. 3, to ensure that the isopipe 300 does not creep or sag too much it comprises a core 302 and at least one outermost coating layer 304. The core is made from a refractory material that is generally resistant to creep such as mullite, zirconia, alumina/zirconia mixtures, yttrium aluminum garnet, yttrium phosphate, silicon carbide, silicon nitride, and other refractory oxides and/or mixtures thereof. The refractory material making up the core can comprise an individual or multiple ceramic materials of varying compositions, particle sizes and/or sintering aids. For example in one embodiment, a ceramic composite employing silicon carbide fibers within an alumina matrix may be employed for the core material. In one aspect, the refractory material making up the core is compatible with conventional glass forming or delivery systems and is capable of enduring temperatures typical in a conventional glass delivery and forming system, for example, up to about 1400, 1500, 1600, 1650, 1700° C. or more. The aforementioned refractory materials are commercially available and one of skill in the art would readily select an appropriate material for use in a particular process. In one aspect, materials for the core portion are selected based on their ability to withstand creep or sag. In another aspect, the material making up the core portion is ceramic. In another aspect, the outermost coating layer 204 that is exposed to the molten glass is made from a material having relatively lower solubility in the manufactured glass than material making up the core. In another aspect, the material making up the outermost layer is selected based on its ability to withstand wear. Examples of suitable materials for the outermost coating layer include ceramics such as zircon, zirconia, yttrium phosphate, or mixtures thereof; or noble metals such as platinum, rhodium, molybdenum, or alloys thereof. The refractory material making up the outermost layer can comprise an individual or multiple ceramic materials of varying compositions, particle sizes and/or sintering aids. In one aspect, the refractory material making up the outermost coating is compatible with conventional glass forming or delivery systems and is capable of enduring temperatures typical in a conventional glass delivery and forming system, for example, up to about 1400, 1500, 1600, 1650, 1700° C. or more. Although the outmost layer may cover the entire core, it is preferred that it at least cover the portion of the isopipe most likely to come into contact with the molten glass.

Creep can be measured by creep rate tests under which a bar of refractory material to be measured is subjected to a three point flexure measurement. The bar to be measured is supported at its ends and loaded at its center. The applied pounds per square inch (psi) can be determined by conventional procedures as set forth in ASTM C-158. The bar is heated and its flexure as a function of time is measured. Measurements are typically recoded as mean creep rates (MCR). In one embodiment, the core region is made from a material having a mean creep rate that is lower than the mean creep rate of the material comprising the outermost layer.

Any number of intermediate layers located between the core and the outermost layer are possible. In FIG. 4, an isopipe 400 is comprised of a core 402, an outermost layer 404 and an intermediate layer 406 located there between. In situations where the core material and outermost layer have a large disparity in their coefficient of thermal expansion (CTE), one or more intermediate layers may be employed to create a CTE gradient between the core and outermost layer. This enables the isopipe to properly expand when subjected to intense temperatures associated with the glass manufacturing process. The layering effect may prevent cracking or spalling of the outermost layer that may otherwise occur in cases where the core and outermost layer have a large CTE mismatch. In one embodiment, the core material 402 has a lower CTE than each successive layer 406, 404 built upon it. Moving from the core to the outermost layer, each successive layer has a relatively higher CTE than the prior. Having an outermost coating layer with relatively higher CTE than the core substrate layer creates compressive force on the surface of the outermost layer as heat is applied to the system. This compressive force increases the strength of the isopipe.

The isopipe must operate at temperatures typically in excess of 1400° C. while supporting its own weight as well as the weight of the molten glass overflowing its sides and trough 206, and at least some tensional force that is transferred back to the isopipe through the fused glass as it is being drawn. Depending on the width of the glass sheets that are to be produced, the isopipe can have an unsupported length of 1.5 meters or more.

To withstand these demanding conditions, isopipes 13 are typically manufactured from isostatically pressed blocks of refractory material. In this invention, the material chosen for the isopipe core (e.g. alumina) is first isostatically pressed into a block. The material is then sintered according to a firing schedule in order to densify the block and to remove organic binder or dispersant materials that are commonly used in the batching process. Sintering also serves to facilitate phase bonding and crystal growth within the structure. The sintered block is then machined using known processes to the specific dimensions required for the core of the final isopipe.

Once the formation of the core is complete, the outermost layer and/or the successive intermediate layers may be formed on the core. One way to accomplish this is through application of a powdered coating layer to the surface of the core. In one embodiment, the coating covers all areas that are likely to contact the molten glass. The coating layer refractory material may comprise binders and adhesives such that the material itself attaches uniformly when applied. Selective heating of the coating material is accomplished through, for example, heating with ultra high frequency microwaves. Such heating concepts are known and will selectively heat and compress the coating material without substantially heating the core. Penetration heating depth can be closely controlled. The final effect of the heating is that the applied layer becomes more dense, sinters and allows bonded grain growth to occur. Once the coating process is complete, successive coating and heating steps may be performed until the desired outermost layer is achieved.

The isopipe may comprise a plurality of successive intermediate layers, each intermediate layer having a different refractory composition that is a composite mixture of the first and second refractory, wherein the concentration of the first refractory material in each intermediate successive layer from the core decreases while the concentration of the second refractory in each successive intermediate layer from the core increases. For example and in one embodiment, the core is comprised of alumina, while the successive intermediate layers are composites of alumina and zircon. The intermediate layers in closest proximity to the core are higher in alumina than zircon while those progressively closer to the outermost layer are respectively higher in zircon content than alumina. In this embodiment, the outermost layer is a material composed primarily of ZrO₂ and SiO₂ such that at least 95% of the material is ZrSnO₄. In such an embodiment the overall isopipe benefits form the advantageous sag conditions of the alumina core while maintaining an interface with the glass (the zircon outermost layer) that will not appreciably react with the molten glass it contacts.

In addition to the powered coating technique, other methods known to those in the art may be employed to create a layer or successive layers on the preformed isopipe core. These additional processing methods include solution coating, slurry coating, thick film coating, plasma spray, thermal spray, flame spray or any other known coating technique. These individual or successive layers may be fired each in succession and prior to the application of the next layer, or multiple layers may be heated all at once.

The heat treatment or densification of the layers themselves may also be accomplished through any number of known techniques including conventional firing or directed laser heating.

It should also be noted that in an alternative embodiment, the core may be machined from a refractory block prior to sintering. The materials employed for the intermediate and outermost layers can then be applied to the core section in sequence and the entire unit can be sintered at once.

The outermost layer and intermediate layers may be any thickness. However, in one embodiment, the outermost layer has a uniform thickness of between 0.5 to 1 cm thick after the densification process.

Although specific embodiments of the invention have been discussed, a variety of modifications to those embodiments which do not depart from the scope and spirit of the invention will be evident to persons of ordinary skill in the art from the disclosure herein. The following claims are intended to cover the specific embodiments set forth herein as well as such modifications, variations, and equivalents.

What is claimed is:

1. An isopipe comprising a body having a configuration adapted for use a fusion process, said body comprising:
a core made from a first refractory material;
an outermost layer covering at least a portion of the core, the outermost layer made from a second refractory material.

2. The isopipe of claim 1, further comprising at least one intermediate layer located between the core and the outermost layer, the intermediate layer made from a third refractory material.

3. The isopipe of claim 1 wherein the first refractory material is more soluble in a glass manufactured by the fusion process than the second refractory material.

4. The isopipe of claim 1 wherein the first refractory material has a lower coefficient of thermal expansion than the second refractory material.

5. The isopipe of claim 1 wherein the first refractory material has a lower mean creep rate than the second refractory material.

6. The isopipe of claim 2 further comprising a plurality of successive intermediate layers, each intermediate layer having a different refractory composition, wherein the CTE of each successive intermediate layer represents a gradient between the CTE of the core and the CTE of the outermost layer.

7. The isopipe of claim 2 further comprising a plurality of successive intermediate layers, each intermediate layer having a different refractory composition that is a composite mixture of the first and second refractory, wherein the concentration of the first refractory material in each intermediate successive layer from the core decreases while the concentration of the second refractory in each successive intermediate layer from the core increases.

8. The isopipe of claim 1 wherein the first refractory material and the second refractory material is ceramic.

9. The isopipe of claim 8 wherein the first refractory material is alumina.

10. The isopipe of claim 8 wherein the second refractory material is zircon.

11. The isopipe of claim 7 wherein the first refractory material is alumina and the second refractory material is zircon.

12. A method for reducing sag of an isopipe used in a fusion process that produces glass sheets comprising
creating a block of a first refractory material;
machining an isopipe core from the block;
coating the core with a slurry comprising a second refractory material and a binder;
heating the slurry to a suitable temperature to eliminate voids, burn off the binder and densify the second refractory material.

13. The method of claim 12 wherein said heating step is performed by ultra high frequency microwave radiation.

14. The method of claim 12, wherein the coating step is performed by applicant of a coating powder.

15. The method of claim 12 further comprising the additional steps of coating the densified second refractory material with a slurry comprising a third refractory material and a binder; and heating the slurry containing the third refractory material to eliminate voids, burn off the binder and densify the third refractory material.

16. The method of claim 15, wherein further steps of coating and heating are performed in sequence so as to apply a plurality of layers on top of the core whereby each successive slurry comprises a different refractory material.

17. The method of claim 12, wherein said first refractory has a predetermined alumina content and said second refractory is a composite of alumina and zircon, the second refractory material having a lower alumina content than the first refractory material.

18. The method of claim 12, wherein said heating step is performed by laser.

19. The isopipe of claim 1 wherein the outmost layer is in direct contact with the core.

20. A glass manufacturing system comprising:
at least one vessel for melting batch materials; and
a forming vessel for receiving the melted batch materials and forming a glass sheet, wherein at least a portion of said forming vessel is made from a refractory material having a core made from one material and at least one layer covering the core made from a refractory material different than the refractory material of the core.
